(19) United States
(12) Patent Application Publication
(10) Pub. No.: US 2021/0118074 A1
(43) Pub. Date: Apr. 22, 2021

(54) Digital Real Estate Transaction Processing Platform

(71) Applicant: Modus Technologies, Inc., Seattle, WA (US)

(72) Inventors: Shuo Liu, Seattle, WA (US); Abbas Abdullah Guvenilir, Seattle, WA (US)

(21) Appl. No.: 17/074,340

(22) Filed: Oct. 19, 2020

Related U.S. Application Data
(60) Provisional application No. 62/923,226, filed on Oct. 18, 2019.

(51) Int. Cl. G06Q 50/16; G06Q 40/02; G06Q 20/40; G06Q 20/02; G06Q 20/10; G06Q 20/22; G06Q 50/26; G06Q 10/10; G06F 9/54

(52) U.S. Cl. CPC G06Q 50/167; G06Q 40/025; G06Q 20/4037; G06Q 20/02; G06Q 50/18; G06Q 20/227; G06Q 50/265; G06Q 10/10; G06F 9/547; G06Q 20/108

(57) ABSTRACT

A system and method for providing a simple and secure user experience by bundling user interactions involved in a real estate transaction event into a fewer number of steps is disclosed. The method includes receiving data in association with a real estate transaction event, determining, using a first classifier on the data, a due date for payment of earnest money deposit to a target escrow account, enabling electronic transfer of the earnest money deposit to the target escrow account based on the due date, authenticating, via a trusted third-party system, user credentials of a buyer in association with a bank, determining an eligibility of one or more bank accounts of the buyer to be a funding source for the payment of the earnest money deposit, receiving, from the buyer, a user selection of an eligible bank account and personal information, transmitting data including the user selection of an eligible bank account and personal information to a digital payment server, and presenting a notification in association with the electronic transfer of the earnest money deposit to the target escrow account.

### CROSS REFERENCE TO RELATED APPLICATIONS

The present application claims priority, under 35 U.S.C. § 119, of U.S. Provisional Patent Application No. 62/923,226, filed Oct. 18, 2019 and entitled “Digital Earnest Money Deposit System, Method and User Interface,” which is incorporated by reference in its entirety.

### BACKGROUND

The specification generally relates to providing a digital platform for tracking a plurality of personalized tasks involved in a real estate transaction event. In particular, the specification relates to a system and method for providing a simple and secure user experience by bundling user interactions involved in a real estate transaction event into a fewer number of steps.

A real estate transaction event is a lengthy process that is generally completed over a period of weeks and filled with many moving parts and procedural formalities. A purchase and sale agreement (PSA) is used after mutual acceptance of an offer between a buyer and a seller in a real estate transaction event. The PSA specifies terms and conditions of the purchase and the time frames in which certain actions must be performed. For example, one of the actions that must be performed is depositing earnest money. However, there is a lack of security, personalization, transparency, and end-to-end optimization in the PSA process. There is a persistent need to simplify the user experience in this massive and yet slow-moving industry.

This background description provided herein is for the purpose of generally presenting the context of the disclosure.

### SUMMARY

The techniques introduced herein overcome the deficiencies and limitations of the prior art at least in part by providing systems and methods for providing a simple and secure user experience by bundling user interactions involved in a real estate transaction event into a fewer number of steps.

According to one innovative aspect of the subject matter described in this disclosure, a method includes: receiving data in association with a real estate transaction event; determining, using a first classifier on the data, a due date for payment of earnest money deposit to a target escrow account; enabling electronic transfer of the earnest money deposit to the target escrow account based on the due date; authenticating, via a trusted third-party system, user credentials of a buyer in association with a bank; determining an eligibility of one or more bank accounts of the buyer to be a funding source for the payment of the earnest money deposit; receiving, from the buyer, a user selection of an eligible bank account and personal information; transmitting data including the user selection of an eligible bank account and personal information to a digital payment server; and presenting a notification in association with the electronic transfer of the earnest money deposit to the target escrow account.

According to another innovative aspect of the subject matter described in this disclosure, a system includes: one or more processors; a memory storing instructions, which when executed cause the one or more processors to: receive data in association with a real estate transaction event; determine, using a first classifier on the data, a due date for payment of earnest money deposit to a target escrow account; enable electronic transfer of the earnest money deposit to the target escrow account based on the due date; authenticate, via a trusted third-party system, user credentials of a buyer in association with a bank; determine an eligibility of one or more bank accounts of the buyer to be a funding source for the payment of the earnest money deposit; receive, from the buyer, a user selection of an eligible bank account and personal information; transmit data including the user selection of an eligible bank account and personal information to a digital payment server; and present a notification in association with the electronic transfer of the earnest money deposit to the target escrow account.

These and other implementations may each optionally include one or more of the following operations. For instance, the operations may include: receiving, from the trusted third-party system, a public token responsive to authenticating the user credentials of the buyer in association with the bank; exchanging the public token with the trusted third-party system for an access token; retrieving the one or more bank accounts from the trusted third-party system using the access token; and determining, using a second classifier on the data, a value of the earnest money deposit. Additionally, these and other implementations may each optionally include one or more of the following features. For instance, the features may include: enabling the electronic transfer of the earnest money deposit to the target escrow account based on the due date comprising determining whether the due date satisfies a threshold period of time available for timely settlement of payment, and enabling the electronic transfer of the earnest money deposit to the target escrow account responsive to determining that the due date satisfies a threshold period of time available for timely settlement of payment; determining the eligibility of the one or more bank accounts of the buyer to be a funding source comprising determining whether an account type of the one or more bank accounts is one from a group of a checking account and a savings account, and making the one or more bank accounts available for the user selection responsive to determining that the account type of the one or more bank accounts is one from a group of a checking account and a savings account; determining the eligibility of the one or more bank accounts of the buyer to be a funding source comprising determining whether an account balance in the one or more bank accounts is sufficient to fund the payment of earnest money deposit, and making the one or more bank accounts available for the user selection responsive to determining that the account balance in the one or more bank accounts is sufficient to fund the payment of earnest money deposit; making the one or more bank accounts unavailable for the user selection responsive to determining that the account balance in the one or more bank accounts is insufficient to fund the payment of earnest money deposit; transmitting the data including the user selection of the eligible bank account and the personal information to the digital payment server comprising transmitting a first application programming interface (API) call to the digital payment server to create a customer account for the buyer using the personal information, transmitting a second API call to the digital payment server to add the user selection of the eligible bank account as a funding source for the electronic transfer of the earnest money deposit to the target escrow account, and transmitting a third API call to the digital payment server to initiate the electronic transfer of the earnest money deposit to the target escrow account; the personal information comprising one or more of a name, a phone number, an email address, a payment sender's address, date of birth, and a unique identifier; enabling electronic transfer of the earnest money deposit to the target escrow account further being based on one or more of a status of the real estate transaction event and an amount of the earnest money deposit.

Other implementations of one or more of these aspects and other aspects include corresponding systems, apparatus, and computer programs, configured to perform the various action and/or store various data described in association with these aspects. Numerous additional features may be included in these and various other implementations, as discussed throughout this disclosure.

The features and advantages described herein are not all-inclusive and many additional features and advantages will be apparent in view of the figures and description. Moreover, it should be understood that the language used in the present disclosure has been principally selected for readability and instructional purposes, and not to limit the scope of the subject matter disclosed herein.

### BRIEF DESCRIPTION OF THE DRAWINGS

The techniques introduced herein are illustrated by way of example, and not by way of limitation in the figures of the accompanying drawings in which like reference numerals are used to refer to similar elements.

FIG. 1 is a high-level block diagram illustrating one embodiment of a system for providing a simple and secure user experience by bundling user interactions involved in a real estate transaction event into a fewer number of steps.

FIG. 2 is a block diagram illustrating one embodiment of a computing device including a PSA application.

FIG. 3A-3I are graphical representations of one embodiment of a process for guiding a user through a process of electronically submitting earnest money deposit to an escrow account.

FIG. 4 is a flow diagram illustrating one embodiment of an example method for facilitating an electronic transfer of digital earnest money deposit.

### DETAILED DESCRIPTION

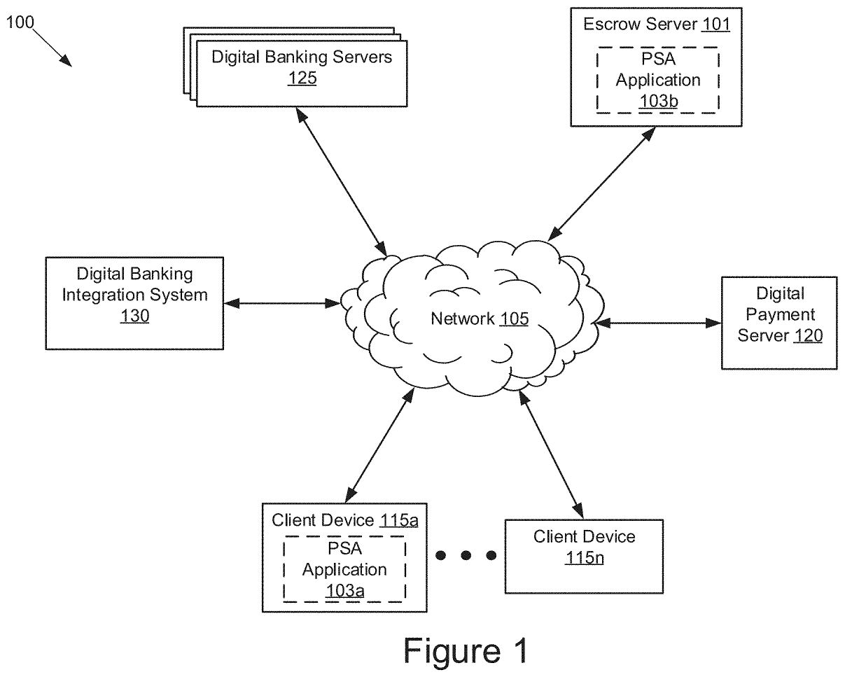

FIG. 1 is a high-level block diagram illustrating one embodiment of a system 100 for providing a simple and secure user experience by bundling user interactions involved in a real estate transaction event into a fewer number of steps. The illustrated system 100 may include one or more client devices 115a . . . 115n that can be accessed by users, an escrow server 101, a digital payment server 120, a digital banking integration system 130, and a plurality of digital banking servers 125, which are communicatively coupled via a network 105 for interaction with one another. In FIG. 1 and the remaining figures, a letter after a reference number, e.g., “115a,” represents a reference to the element having that particular reference number. A reference number in the text without a following letter, e.g., “115,” represents a general reference to instances of the element bearing that reference number.

The network 105 may be a conventional type, wired or wireless, and may have numerous different configurations including a star configuration, token ring configuration, or other configurations. Furthermore, the network 105 may include any number of networks and/or network types. For example, the network 105 may include a local area network (LAN), a wide area network (WAN) (e.g., the Internet), virtual private networks (VPNs), mobile (cellular) networks, wireless wide area network (WWANs), WiMAX® networks, Bluetooth® communication networks, peer-to-peer networks, and/or other interconnected data paths across which multiple devices may communicate, various combinations thereof, etc. The network 105 may also be coupled to or include portions of a telecommunications network for sending data in a variety of different communication protocols. In some implementations, the network 105 may include Bluetooth communication networks or a cellular communications network for sending and receiving data including via short messaging service (SMS), multimedia messaging service (MMS), hypertext transfer protocol (HTTP), direct data connection, WAP, email, etc. In some implementations, the data transmitted by the network 105 may include packetized data (e.g., Internet Protocol (IP) data packets) that is routed to designated computing devices coupled to the network 105. Although FIG. 1 illustrates one network 105 coupled to the client devices 115, the escrow server 101, the digital payment server 120, the digital banking integration system 130, and the plurality of digital banking servers 125, in practice one or more networks 105 can be connected to these entities.

The client devices 115a . . . 115n (also referred to individually and collectively as 130) may be computing devices having data processing and communication capabilities. In some implementations, a client device 115 may include a memory, a processor (e.g., virtual, physical, etc.), a power source, a network interface, software and/or hardware components, such as a display, graphics processing unit (GPU), wireless transceivers, keyboard, camera (e.g., webcam), sensors, firmware, operating systems, web browsers, applications, drivers, and various physical connection interfaces (e.g., USB, HDMI, etc.). The client devices 115a . . . 115n may couple to and communicate with one another and the other entities of the system 100 via the network 105 using a wireless and/or wired connection. Examples of client devices 115 may include, but are not limited to, laptops, desktops, tablets, mobile phones (e.g., smartphones, feature phones, etc.), server appliances, servers, virtual machines, smart TVs, media streaming devices, user wearable computing devices or any other electronic device capable of accessing a network 105. In the example of FIG. 1, the client device 115a is configured to implement a PSA application 103a described in more detail below. The client device 115 includes a display for viewing information provided by one or more entities coupled to the network 105. For example, the client device 115 may be adapted to send and receive data to and from the escrow server 101. While two or more client devices 115 are depicted in FIG. 1, the system 100 may include any number of client devices 115. In addition, the client devices 115a . . . 115n may be the same or different types of computing devices.

In the example of FIG. 1, each one of the escrow server 101, a plurality of digital banking servers 125, a digital banking integration system 130, and a digital payment server 120 may be, or may be implemented by, a computing device including a processor, a memory, applications, a database, and network communication capabilities.

In the example of FIG. 1, the components of the escrow server 101 are configured to implement a PSA application 103b described in more detail below. In some implementations, the escrow server 101 may provide a service for facilitating a transfer of property by collecting items including signed documents and funds from a buyer and a seller in a real estate transaction and then distributing the funds and recording documents to complete the sale in accordance with an executed PSA via web, mobile, and/or cloud applications. While the examples herein may describe one aspect of enforcing PSA, such as earnest money deposit, it should be understood that the PSA application 103 may be configured to facilitate and guide the user through the end-to-end PSA process.

In some implementations, the escrow server 101 may be a hardware server, a software server, or a combination of software and hardware. For example, the escrow server 101 may include one or more hardware servers, virtual servers, server arrays, storage devices and/or systems, etc., and/or may be centralized or distributed/cloud-based. In some implementations, the escrow server 101 may include one or more virtual servers, which operate in a host server environment and access the physical hardware of the host server including, for example, a processor, a memory, applications, a database, storage, network interfaces, etc., via an abstraction layer (e.g., a virtual machine manager). In some implementations, the escrow server 101 may be a Hypertext Transfer Protocol (HTTP) server, a Representational State Transfer (REST) service, or other server type, having structure and/or functionality for processing and satisfying content requests and/or receiving content from one or more of the client devices 115, the digital banking server 125, the digital banking integration system 130, and the digital payment server 120 that are coupled to the network 105.

Also, instead of or in addition, the escrow server 120 may implement its own application programing interface (API) for the transmission of instructions, data, results, and other information between the escrow server 101 and an application installed or otherwise implemented on one or more of the client device 115, the digital banking server 125, the digital banking system 130, and the digital payment server 120. For example, the API may be a software interface exposed over the HTTP protocol by the escrow server 101. The API exposes internal data and functionality of the service hosted by the escrow server 101 to API requests originating from one or more of the PSA application 103, the digital banking server 125, the digital banking system 130, and the digital payment server 120. In one example, the PSA application 103b implemented by the escrow server 101 passes an authenticated request including a set of parameters for information to one or more of the digital banking integration system 130, the digital banking servers 125, and the digital payment server 120 and receives an object (e.g., XML, or JSON) with associated results. The escrow server 101 may also include a database coupled to the escrow server 101 over the network 105 to store structured data in a relational database and a file system (e.g., HDFS, NFS, etc) for unstructured or semi-structured data.

In some implementations, the escrow server 101 sends and receives data to and from other entities of the system 100 via the network 105. For example, the escrow server 101 sends and receives data including instructions to and from the client device 115. In some implementations, the escrow server 101 may serve as a middle layer and permit interactions between the client device 115 and one or more of the digital payment server 120, the digital banking server 125, and the digital banking integration system 130 to flow through and from the escrow server 101 for security and convenience. For example, user interactions or information between the client device 115 and one or more of the entities 120, 125, and 130 passes through the escrow server 101 in association with a real estate transaction event. In some implementations, the escrow server 101 may be operable to enable the users of the client devices 115a . . . 115n to create and manage individual user accounts; receive, store, and/or manage transfer of documents and funds between a buyer and a seller in a real estate transaction, create personalized task lists, etc. The escrow server 101 may send data to and receive data from the other entities of the system 100 including the client devices 115, the digital banking server 125, the digital banking integration system 130, and the digital payment server 120 via the network 105. It should be understood that the escrow server 101 is not limited to providing the above-noted acts and/or functionality and may include other network-accessible services. In addition, while a single escrow server 120 is depicted in FIG. 1, it should be understood that there may be any number of escrow servers 101 or a server cluster.

In the example of FIG. 1, the system 100 includes a plurality of digital banking servers 125. The plurality of digital banking servers 125 may communicate with one or more entities of the system 100, such as the digital banking integration system 130, the digital payment server 120, and the escrow server 101. A digital banking server 125 may be configured to implement an online banking service for authorized users maintaining a bank account with a financial banking institution supporting the infrastructure and operation of the digital banking server 125. For example, the online banking service enables the users to handle account management and perform account transactions directly with the bank through the Internet via web, mobile, and/or cloud applications on the one or more client devices 115. The online banking service also allows users to monitor and transfer funds between accounts and to and from one or more entities of the system 100, such as the digital payment server 120. For example, the accounts may include a checking account, a savings account, a money market account, certificate of deposit (CD) account, a credit card account, a mortgage account, a student loan account, a retirement savings account, a brokerage account, etc. In another example, the type of bank account may include a personal bank account, a joint bank account, a business bank account, etc. In some implementations, each of the plurality of digital banking servers 125 may be configured to provide or facilitate an application programming interface (API) that allows trusted third-party applications or systems to access banking information for performing the functionality described herein.

In the example of FIG. 1, the digital banking integration system 130 may be a trusted third-party system configured to connect the plurality of digital banking servers 125 with an application, such as the PSA application 103 in the escrow server 101. The digital banking integration system 130 allows users to link their bank account securely using their login credentials. The digital banking integration system 130 securely provides the PSA application 103 with a user's banking account information via its own API once the user authenticates with the online banking service provided by the digital banking server 125 via the digital banking integration system 130. For example, the banking account information may include an account identifier, account holder name, routing number, balance, etc. In some implementations, the digital banking integration system 130 cooperates with the digital payment server 120 to enable an electronic transfer of funds (e.g., earnest money deposit) from the user's bank account to a target account (e.g., escrow account) or vice versa in a real estate transaction event.

In the example of FIG. 1, the digital payment server 120 may be configured to implement an online payment service and an automated clearing house (ACH) payment network for processing electronic payments by a variety of payment methods including credit card and bank-based payments such as direct debit and wire transfer. The digital payment server 120 enables creation of a customer account via its own API for receiving funds from a bank account of a user (e.g., payment sender) after authentication via the digital banking integration system 130.

The PSA application 103 may include software and/or logic to provide the functionality for providing a simple and secure user experience by bundling user interactions involved in a real estate transaction event into a fewer number of steps. In some implementations, the PSA application 103 may be implemented using programmable or specialized hardware, such as a field-programmable gate array (FPGA) or an application-specific integrated circuit (ASIC). In some implementations, the PSA application 103 may be implemented using a combination of hardware and software. In other implementations, the PSA application 103 may be stored and executed on a combination of the client devices 115 and the escrow server 101, or by any one of the client devices 115 or escrow server 101.

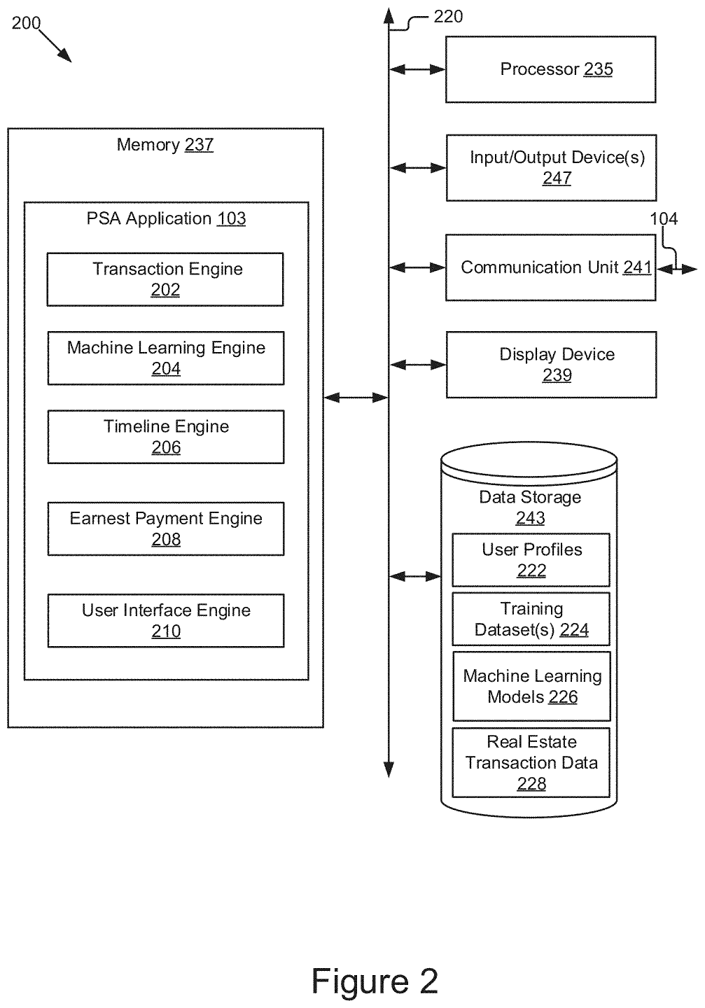

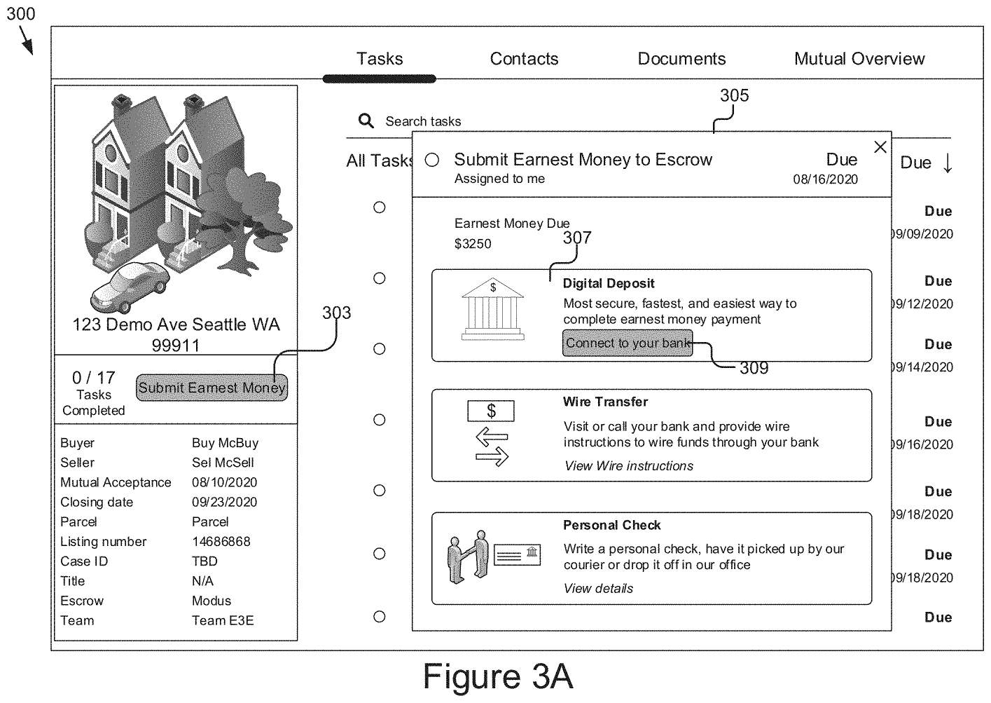

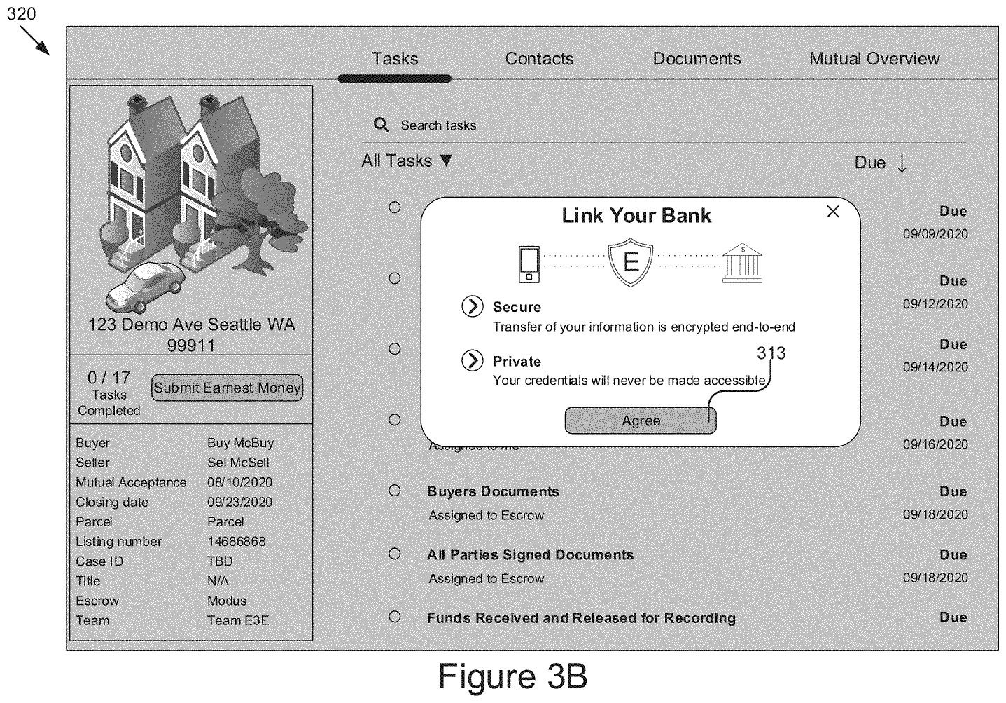

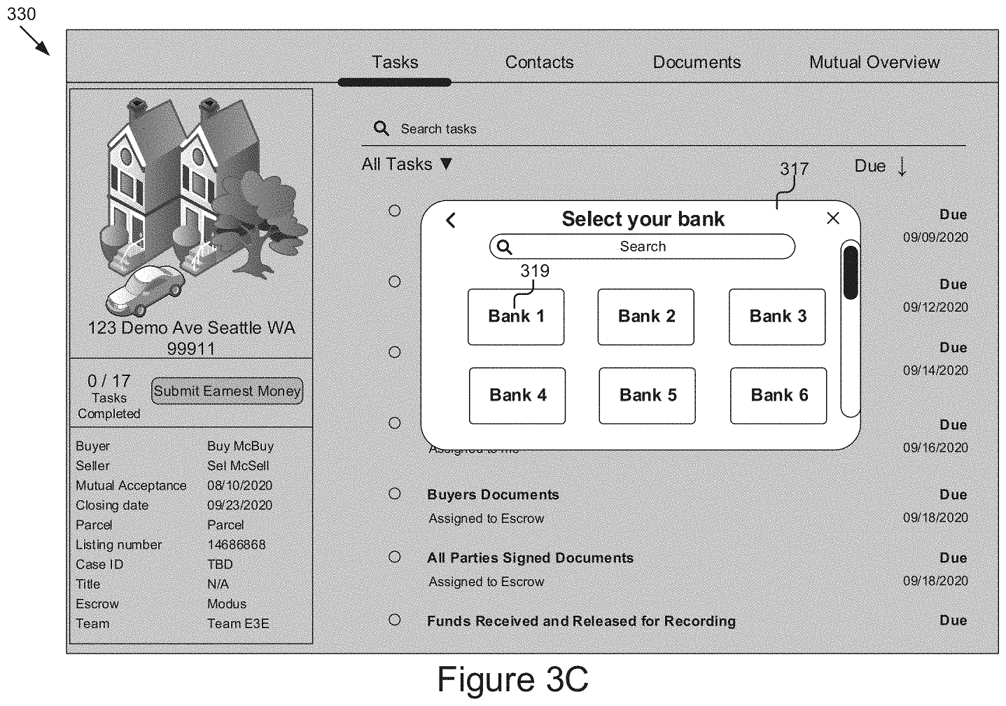

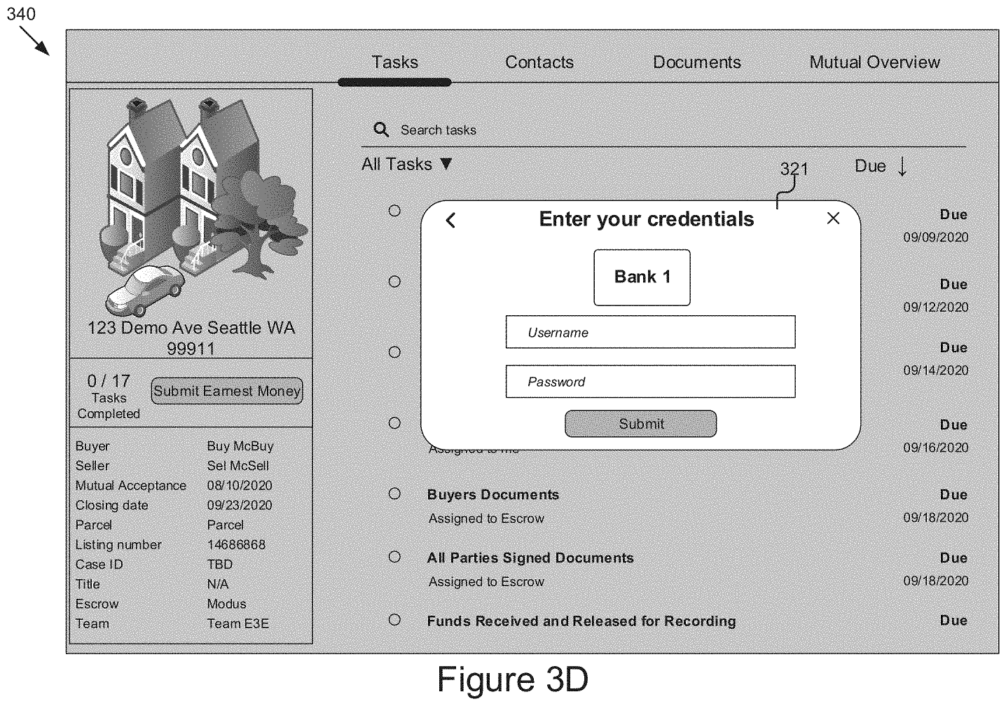

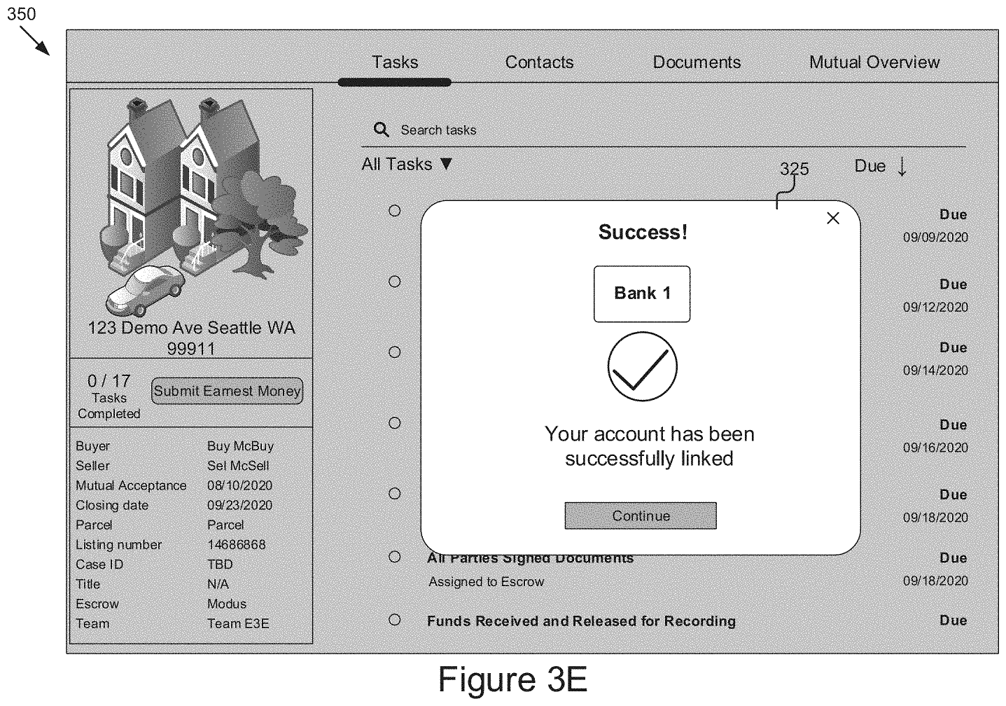

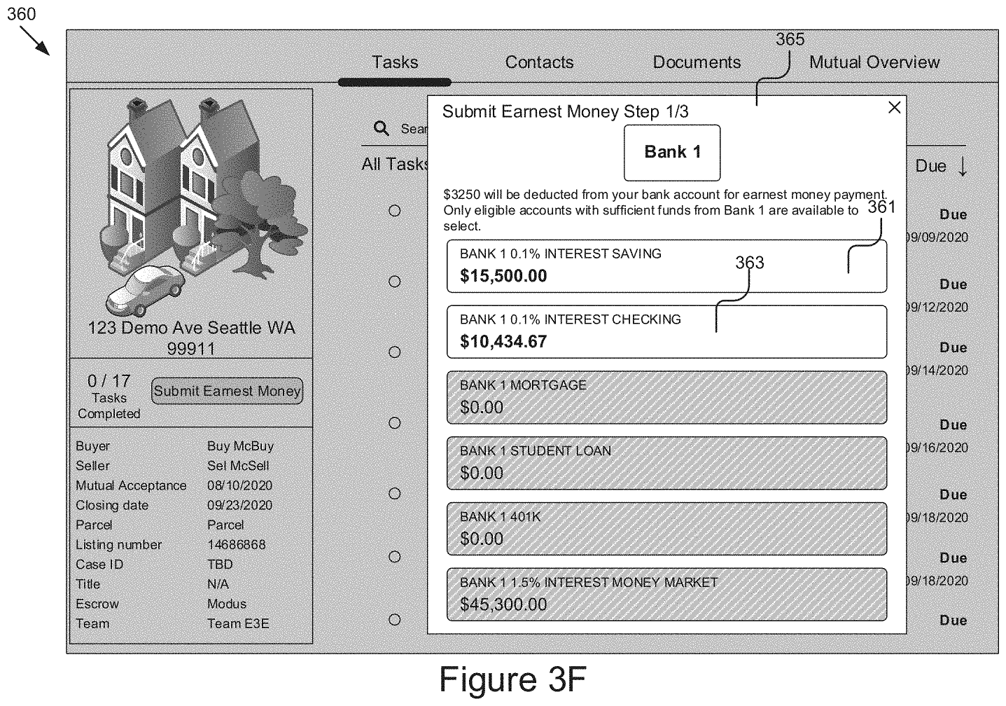

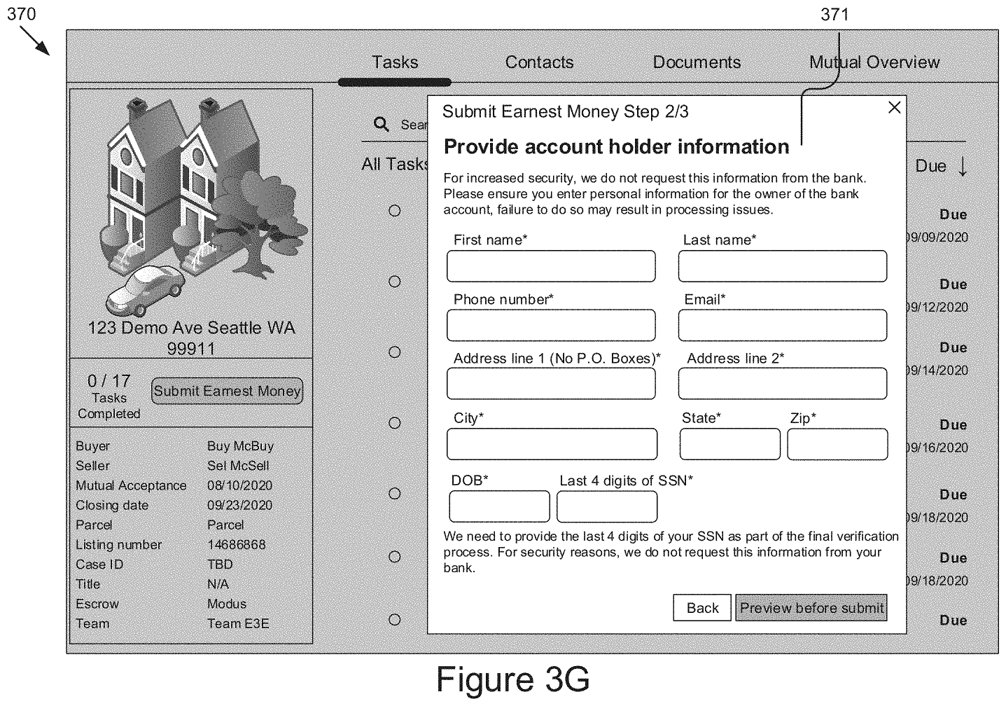

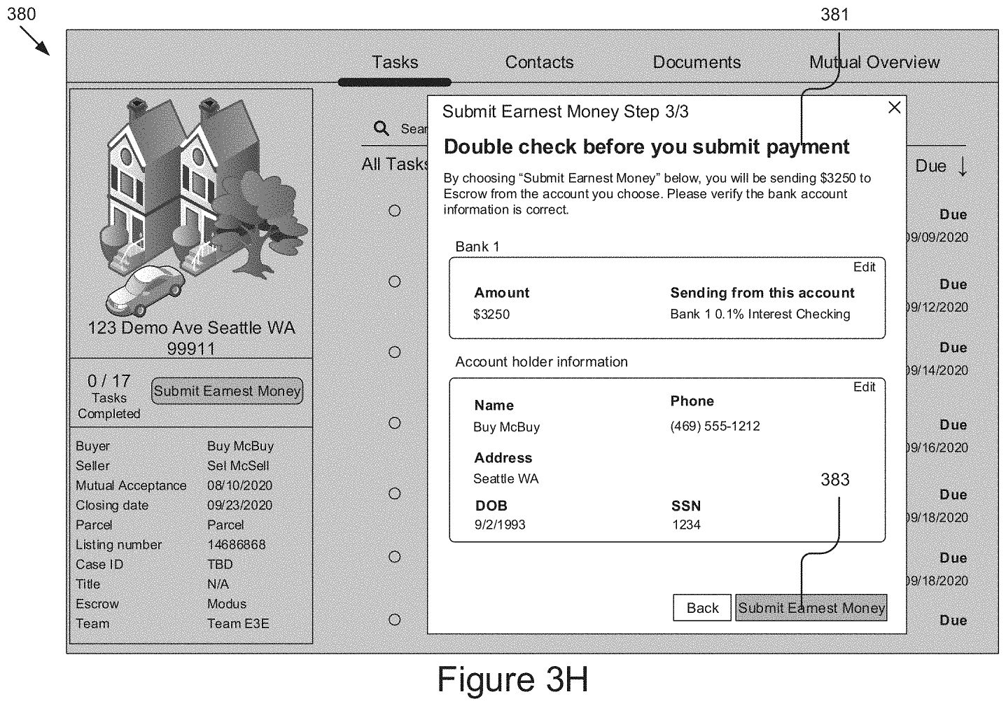

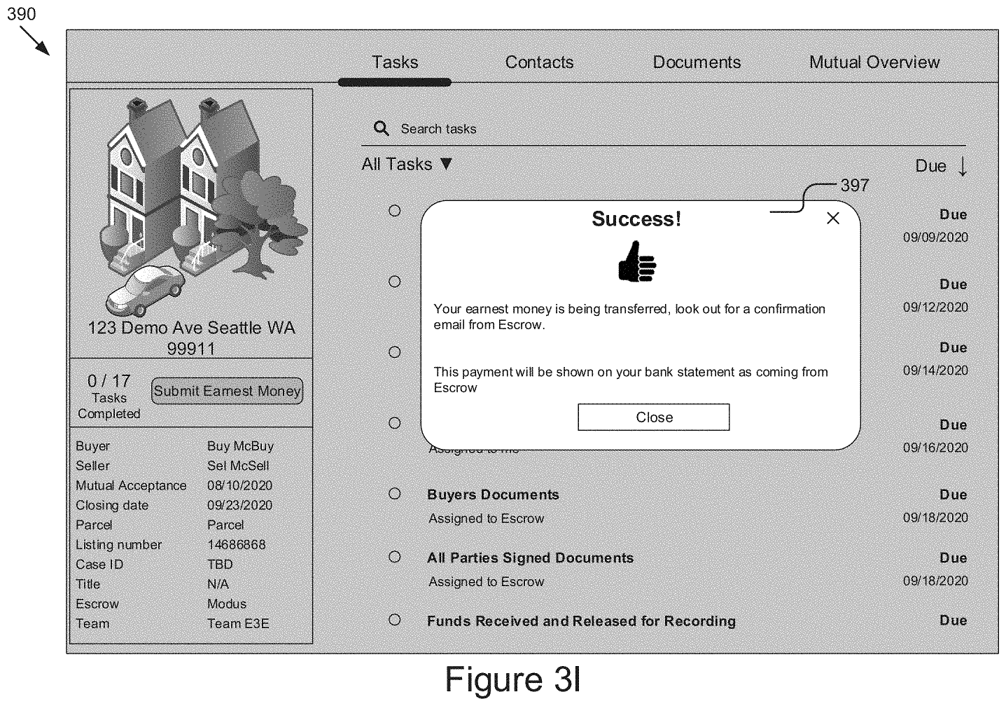

In some implementations, the PSA application 103a may be a thin-client application with some functionality executed on the client device 115 and additional functionality executed on the escrow server 101 by the PSA application 103b. In some implementations, the PSA application 103 may generate and present various user interfaces to perform these acts and/or functionality, which may in some cases be based at least in part on information received from the escrow server 101, the client device 115, one or more of the digital banking servers 125, the digital banking integration system 130, and/or the digital payment server 120 via the network 105. Non-limiting example user interfaces that may be generated for display by the PSA application 103 are depicted in FIGS. 3A-3I. In some implementations, the PSA application 110 is code operable in a web browser, a web application accessible via a web browser, a native application (e.g., mobile application, installed application, etc.) on the client device 115, a combination thereof, etc. Additional structure, acts, and/or functionality of the PSA application 103 is further discussed below with reference to at least FIG. 2.

In some implementations, the PSA application 103 may require users to be registered with the escrow server 101 to access the acts and/or functionality described herein. For example, to access various acts and/or functionality provided by the PSA application 103, the PSA application 103 may require a user to authenticate his/her identity. For example, the PSA application 103 may require a user seeking access to authenticate their identity by inputting credentials in an associated user interface. In another example, the PSA application 103 may interact with a federated identity server (not shown) to register and/or authenticate the user by scanning and verifying biometrics including facial attributes, fingerprint, and voice.

It should be understood that the system 100 illustrated in FIG. 1 is representative of an example system for providing a simple and secure user experience by bundling user interactions involved in a real estate transaction event into a fewer number of steps, and that a variety of different system environments and configurations are contemplated and are within the scope of the present disclosure. For instance, various functionality may be moved from the escrow server 101 to a client device 115, or vice versa and some implementations may include additional or fewer computing devices, services, and/or networks, and may implement various functionality client or server-side. Further, various entities of the system 100 may be integrated into to a single computing device or system or additional computing devices or systems, etc.

FIG. 2 is a block diagram illustrating one embodiment of a computing device 200 including a PSA application 103. The computing device 200 may also include a processor 235, a memory 237, a display device 239, a communication unit 241, an input/output device(s) 247, and a data storage 243, according to some examples. The components of the computing device 200 are communicatively coupled by a bus 220. In some implementations, the computing device 200 may be representative of the client device 115, the escrow server 101, or a combination of the client device 115 and the escrow server 101. In such implementations where the computing device 200 is the client device 115 or the escrow server 101, it should be understood that the client device 115, and the escrow server 101 may take other forms and include additional or fewer components without departing from the scope of the present disclosure. For example, while not shown, the computing device 200 may include sensors, additional processors, and other physical configurations. Additionally, it should be understood that the computer architecture depicted in FIG. 2 could be applied to other entities of the system 100 with various modifications, including, for example, the servers 125.

The processor 235 may execute software instructions by performing various input/output, logical, and/or mathematical operations. The processor 235 may have various computing architectures to process data signals including, for example, a complex instruction set computer (CISC) architecture, a reduced instruction set computer (RISC) architecture, and/or an architecture implementing a combination of instruction sets. The processor 235 may be physical and/or virtual, and may include a single processing unit or a plurality of processing units and/or cores. In some implementations, the processor 235 may be capable of generating and providing electronic display signals to a display device 239, supporting the display of images, capturing and transmitting images, and performing complex tasks including various types of feature extraction and sampling. In some implementations, the processor 235 may be coupled to the memory 237 via the bus 220 to access data and instructions therefrom and store data therein. The bus 220 may couple the processor 235 to the other components of the computing device 200 including, for example, the memory 237, the communication unit 241, the display device 239, the input/output device(s) 247, and the data storage 243.

The memory 237 may store and provide access to data for the other components of the computing device 200. The memory 237 may be included in a single computing device or distributed among a plurality of computing devices as discussed elsewhere herein. In some implementations, the memory 237 may store instructions and/or data that may be executed by the processor 235. The instructions and/or data may include code for performing the techniques described herein. For example, as depicted in FIG. 2, the memory 237 may store the PSA application 103. The memory 237 is also capable of storing other instructions and data, including, for example, an operating system, hardware drivers, other software applications, databases, etc. The memory 237 may be coupled to the bus 220 for communication with the processor 235 and the other components of the computing device 200.

The memory 237 may include one or more non-transitory computer-usable (e.g., readable, writeable) device, a static random access memory (SRAM) device, a dynamic random access memory (DRAM) device, an embedded memory device, a discrete memory device (e.g., a PROM, FPROM, ROM), a hard disk drive, an optical disk drive (CD, DVD, Blu-ray™, etc.) mediums, which can be any tangible apparatus or device that can contain, store, communicate, or transport instructions, data, computer programs, software, code, routines, etc., for processing by or in connection with the processor 235. In some implementations, the memory 237 may include one or more of volatile memory and non-volatile memory. It should be understood that the memory 237 may be a single device or may include multiple types of devices and configurations.

The bus 220 may represent one or more buses including an industry standard architecture (ISA) bus, a peripheral component interconnect (PCI) bus, a universal serial bus (USB), or some other bus providing similar functionality. The bus 220 may include a communication bus for transferring data between components of the computing device 200 or between computing device 200 and other components of the system 100 via the network 105 or portions thereof, a processor mesh, a combination thereof, etc. In some implementations, the PSA application 103 and various other software operating on the computing device 200 (e.g., an operating system, device drivers, etc.) may cooperate and communicate via a software communication mechanism implemented in association with the bus 220. The software communication mechanism may include and/or facilitate, for example, inter-process communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication may be configured to be secure (e.g., SSH, HTTPS, etc.).

The display device 239 may be any conventional display device, monitor or screen, including but not limited to, a liquid crystal display (LCD), light emitting diode (LED), organic light-emitting diode (OLED) display or any other similarly equipped display device, screen or monitor. The display device 239 represents any device equipped to display user interfaces, electronic images, and data as described herein. In some implementations, the display device 239 may output display in binary (only two different values for pixels), monochrome (multiple shades of one color), or multiple colors and shades. The display device 239 is coupled to the bus 220 for communication with the processor 235 and the other components of the computing device 200. In some implementations, the display device 239 may be a touch-screen display device capable of receiving input from one or more fingers of a user. For example, the display device 239 may be a capacitive touch-screen display device capable of detecting and interpreting multiple points of contact with the display surface. In some implementations, the computing device 200 (e.g., client device 115) may include a graphics adapter (not shown) for rendering and outputting the images and data for presentation on display device 239. The graphics adapter (not shown) may be a separate processing device including a separate processor and memory (not shown) or may be integrated with the processor 235 and memory 237.

The input/output (I/O) device(s) 247 may include any standard device for inputting or outputting information and may be coupled to the computing device 200 either directly or through intervening I/O controllers. In some implementations, the input device 247 may include one or more peripheral devices. Non-limiting example I/O devices 247 include a touch screen or any other similarly equipped display device equipped to display user interfaces, electronic images, and data as described herein, a touchpad, a keyboard, a scanner, a stylus, an audio reproduction device (e.g., speaker), a microphone array, a barcode reader, an eye gaze tracker, a sip-and-puff device, and any other I/O components for facilitating communication and/or interaction with users. In some implementations, the functionality of the input/output device 247 and the display device 239 may be integrated, and a user of the computing device 200 (e.g., client device 115) may interact with the computing device 200 by contacting a surface of the display device 239 using one or more fingers. For example, the user may interact with an emulated (i.e., virtual or soft) keyboard displayed on the touch-screen display device 239 by using fingers to contact the display in the keyboard regions.

The communication unit 241 is hardware for receiving and transmitting data by linking the processor 235 to the network 105 and other processing systems via signal line 104. The communication unit 241 receives data such as requests from the client device 115 and transmits the requests to the PSA application 103, for example a request to link a bank account for earnest money deposit payment. The communication unit 241 also transmits information including media to the client device 115 for display, for example, in response to the request. The communication unit 241 is coupled to the bus 220. In some implementations, the communication unit 241 may include a port for direct physical connection to the client device 115 or to another communication channel. For example, the communication unit 241 may include an RJ45 port or similar port for wired communication with the client device 115. In other implementations, the communication unit 241 may include a wireless transceiver (not shown) for exchanging data with the client device 115 or any other communication channel using one or more wireless communication methods, such as IEEE 802.11, IEEE 802.16, Bluetooth® or another suitable wireless communication method.

In yet other implementations, the communication unit 241 may include a cellular communications transceiver for sending and receiving data over a cellular communications network such as via short messaging service (SMS), multimedia messaging service (MMS), hypertext transfer protocol (HTTP), direct data connection, WAP, e-mail or another suitable type of electronic communication. In still other implementations, the communication unit 241 may include a wired port and a wireless transceiver. The communication unit 241 also provides other conventional connections to the network 105 for distribution of files and/or media objects using standard network protocols such as TCP/IP, HTTP, HTTPS, and SMTP as will be understood to those skilled in the art.

The data storage 243 is a non-transitory memory that stores data for providing the functionality described herein. In some implementations, the data storage 243 may be coupled to the components 235, 237, 239, 241, and 247 via the bus 220 to receive and provide access to data. In some implementations, the data storage 243 may store data received from other elements of the system 100 including, for example, entities 125, 120, 130, and/or the PSA applications 103, and may provide data access to these entities. The data storage 243 may store, among other data, user profiles 222, training datasets 224, machine learning models 226, and real estate transaction data 228. The data storage 243 stores data associated with the facilitating a completion of a real estate transaction and other functionality as described herein. For example, the data storage 243 may store data relating to earnest payment including buyer's earnest payment amount, payment due date, escrow bank account, etc. Additionally, the data storage 243 may store user accounts associated with buyers, sellers, and realtors. The data stored in the data storage 243 is described below in more detail.

The data storage 243 may be included in the computing device 200 or in another computing device and/or storage system distinct from but coupled to or accessible by the computing device 200. The data storage 243 may include one or more non-transitory computer-readable mediums for storing the data. In some implementations, the data storage 243 may be incorporated with the memory 237 or may be distinct therefrom. The data storage 243 may be a dynamic random access memory (DRAM) device, a static random access memory (SRAM) device, flash memory, or some other memory devices. In some implementations, the data storage 243 may include a database management system (DBMS) operable on the computing device 200. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations. In other implementations, the data storage 243 also may include a non-volatile memory or similar permanent storage device and media including a hard disk drive, a CD-ROM device, a DVD-ROM device, a DVD-RAM device, a DVD-RW device, a flash memory device, or some other mass storage device for storing information on a more permanent basis.

It should be understood that other processors, operating systems, sensors, displays, and physical configurations are possible.

As depicted in FIG. 2, the memory 237 may include the PSA application 103.

In some implementations, the PSA application 103 may include a transaction engine 202, a machine learning engine 204, a timeline engine 206, an earnest payment engine 208, and a user interface engine 210. The components 202, 204, 206, 208, and 210 may be communicatively coupled by the bus 220 and/or the processor 235 to one another and/or the other components 237, 239, 241, 243, and 247 of the computing device 200 for cooperation and communication. The components 202, 204, 206, 208, and 210 may each include software and/or logic to provide their respective functionality. In some implementations, the components 202, 204, 206, 208, and 210 may each be implemented using programmable or specialized hardware including a field-programmable gate array (FPGA) or an application-specific integrated circuit (ASIC). In some implementations, the components 202, 204, 206, 208, and 210 may each be implemented using a combination of hardware and software executable by the processor 235. In some implementations, each one of the components 202, 204, 206, 208, and 210 may be sets of instructions stored in the memory 237 and configured to be accessible and executable by the processor 235 to provide their acts and/or functionality. In some implementations, the components 202, 204, 206, 208, and 210 may send and receive data, via the communication unit 241, to and from one or more of the client devices 115, the digital banking server 125, the escrow server 101, the digital banking integration system 130, and the digital payment server 120.

The transaction engine 202 may include software and/or logic to provide functionality for managing an online platform to facilitate the closing process in a real estate transaction event including buying and selling of a real estate property. In some implementations, the transaction engine 202 creates a user profile 222 for a registered user with the escrow server 101. For example, the registered user may include a buyer, a seller, a realtor, a real estate agent, etc. The user profile 222 may include one or more of the user's name, type of user (e.g., buyer, seller, realtor, etc.), real estate listings, age, gender, location, address, phone number, and other demographic information. The transaction engine 202 may receive information from other components of the PSA application 103 and use the received information to update the user profile 222 accordingly. The transaction engine 202 stores and updates the user profiles 222 in the data storage 243.

The transaction engine 202 receives an indication that a transaction is initiated for a real estate listing on the online platform and tracks a status of the transaction. For example, a real estate agent for a seller may indicate that a real estate listing on the online platform is pending sale. The transaction engine 202 determines details of the transaction. In one example, the transaction engine 202 parses real estate transaction documents received in associated with a real estate listing and determines the transaction details. The transaction details may include, for example, the address of the real estate listing, the primary buyer, the primary seller, one or more real estate agents, mutual acceptance date of an offer, etc. The transaction engine 202 cooperates with the timeline engine 206, the earnest payment engine 208, and the user interface engine 210 to facilitate the closing process of the real estate transaction. For each real estate transaction, the transaction engine 202 maintains and stores one or more of a task list, contact details of the parties involved, real estate documents (e.g., buyer's agent agreement, purchase agreement, seller disclosures, home inspection report, title insurance policy, property deed, etc.), a timeline of the closing process, transaction details, real estate statutory and regulatory requirements in a geographical location of the real estate transaction, etc. in the real estate transaction data 228 in the data storage 243.

In some implementations, the transaction engine 202 curates one or more training datasets 224 based on the data received in association with closing of a plurality of real estate transactions on the online platform. The machine learning engine 204 described in detail below uses the training datasets 224 to train the machine learning models. Example training datasets 224 curated by the transaction engine 202 include, but not limited to, a dataset containing real estate transactions by geographical location (e.g., cities, countries, neighborhoods, zip codes, etc.), a dataset containing real estate transactions in the current month, over a quarter, over a year, etc., a dataset containing real estate transactions by property type (e.g., single family home, condo, townhome, etc.), a dataset containing real estate transactions by price range, a dataset containing real estate transactions by credit score of the buyer, a dataset containing real estate market data, a dataset containing real estate listing data (price/square feet, price asked, price paid, days on the market, etc.), a dataset containing real estate demographic data (median income, homelessness, education, crime rates, population density, school district, etc.) etc. In some implementations, the transaction engine 202 accesses a publicly available real estate dataset that may serve as a training dataset 224. For example, the transaction engine 202 accesses one or more of tax records, mortgage and lender date, commercial records, multiple listing services, foreclosure reports, etc. The transaction engine 202 stores the curated training datasets 224 in the data storage 243.

The machine learning engine 204 may include software and/or logic to provide functionality for training one or more machine learning models 226 or classifiers using the training datasets 224 created or aggregated by the transaction engine 202. In some implementations, the machine learning engine 204 may be configured to incrementally adapt and train the one or more machine learning models every threshold period of time. For example, the machine learning engine 204 may incrementally train the machine learning models every week, every month, every quarter, etc. based on the aggregated dataset. In some implementations, a machine learning model 226 is a neural network model and includes a layer and/or layers of memory units where memory units each have corresponding weights. A variety of neural network models may be utilized including feed forward neural networks, convolutional neural networks, recurrent neural networks, radial basis functions, other neural network models, as well as combinations of several neural networks. Additionally, or alternatively, the machine learning model 226 may represent a variety of other machine learning techniques in addition to neural networks, for example, support vector machines, decision trees, Bayesian networks, random decision forests, k-nearest neighbors, linear regression, least squares, hidden Markov models, other machine learning techniques, and/or combinations of machine learning techniques.

In some implementations, the machine learning engine 204 may train the one or more machine learning models 226 for a variety of machine learning tasks including estimating an earnest money deposit value, identifying a task, activity, or contingency in a real estate transaction, determining a due date for different contingencies in a real estate transaction, determine a timeline for closing a real estate transaction, etc. In some implementations, the machine learning model 226 may be trained to perform a single task. In other implementations, the machine learning model 226 may be trained to perform multiple tasks.

In some implementations, the machine learning engine 204 determines a plurality of training instances or samples from the labelled dataset curated by the transaction engine 202. A training instance can include, for example, an instance of a real estate transaction including details about the transaction price, geographical location, buyer credit score, property type, and a target label of earnest money deposit. The machine learning engine 204 may apply a training instance as input to a machine learning model 226. In some implementations, the machine learning engine 204 may train the machine learning model 226 using any one of at least one of supervised learning (e.g., support vector machines, neural networks, logistic regression, linear regression, stacking, gradient boosting, etc.), unsupervised learning (e.g., clustering, neural networks, singular value decomposition, principal component analysis, etc.), or semi-supervised learning (e.g., generative models, transductive support vector machines, etc.). Additionally, or alternatively, machine learning models 226 in accordance with some implementations may be deep learning networks including recurrent neural networks, convolutional neural networks (CNN), networks that are a combination of multiple networks, etc. The machine learning engine 204 may generate a predicted machine learning model output by applying training input to the machine learning model 226. Additionally, or alternatively, the machine learning engine 204 may compare the predicted machine learning model output with a known target label (e.g., earnest money deposit value) from the training instance and, using the comparison, update one or more weights in the machine learning model 226. In some implementations, the machine learning engine 204 may update the one or more weights by backpropagating the difference over the entire machine learning model 226.

In some implementations, the machine learning engine 204 may test a trained machine learning model 226 and update it accordingly. The machine learning engine 204 may partition the labelled dataset obtained from the transaction engine 202 into a testing dataset and a training dataset. The machine learning engine 204 may apply a testing instance from the training dataset as input to the trained machine learning model 226. A predicted output generated by applying a testing instance to the trained machine learning model 226 may be compared with a known output for the testing instance to update an accuracy value (e.g., an accuracy percentage) for the machine learning model 226.

The timeline engine 206 may include software and/or logic to provide functionality for determining a timeline of a plurality of contingencies, activities, and important due dates in a closing process of a real estate transaction or contract. For example, the plurality of contingencies in a real estate contract may include, but are not limited to, an inspection contingency, a financing contingency, a title contingency, an appraisal contingency, a home sale contingency, an attorney review contingency, etc. In some implementations, the timeline engine 206 may be configured to implement one or more machine learning models 226 trained by the machine learning engine 204 to execute its functionality as described herein.

The timeline engine 206 receives real estate transaction details including a mutual acceptance of an offer in a real estate transaction event from the transaction engine 202. In some implementations, the timeline engine 206 uses the mutual acceptance of the offer to retrieve real estate statutory and regulatory requirements for the geographical location where the real estate transaction is taking place and generates a timeline of a plurality of contingencies, activities, and important due dates to be in compliance with the real estate statutory and regulatory requirements. In some implementations, the timeline engine 206 inputs the real estate transaction details including a mutual acceptance of an offer into a trained machine learning model 226 to determine a timeline template. In one example, the trained machine learning module 226 may take as input the mutual acceptance of the offer, address of the real estate property, buyer and seller requirements, local regulatory requirements, etc. and determine a timeline template that includes the plurality of contingencies, activities, and important due dates in the closing process of the real estate transaction. One example of an important due date that is determined is the earnest money deposit due date. The items in a timeline template may be listed chronologically with mutual acceptance date at the top or at the beginning of the timeline and possession date at the bottom or the end of the timeline. The due date for the earnest money deposit activity immediately follows the mutual acceptance date in the timeline template. In some implementations, the due for the earnest money deposit activity is dependent on the mutual acceptance date and the closing date. An activity may comprise multiple sub-activities. In such a case, the timeline engine 206 identifies a date of one of the sub-activities that is closest as the due date of the activity. For example, a financing contingency may include due dates for the following sub-activities: a buyer application submission due by Sep. 19, 2019, a seller request to review application due by Sep. 16, 2019 (extraneous reasons), and a seller retains rights to terminate by Sep. 20, 2019. The financing contingency has an effective due date of Sep. 16, 2019. This means this contingency will come before anything that is due after Sep. 16, 2019, and after anything that is due before Sep. 16, 2019. The timeline engine 206 may configure the granularity between items in a timeline template from a range of days to hours. An advantage of the timeline template is that it enables the closing process to be both expedited and less prone to error because it is personalized to the real estate transaction. The timeline engine 206 may set up different milestones along the timeline for periodic check-ins for the user to follow and instruct the user interface engine 210 to flag or highlight high risk items in the timeline.

The earnest payment engine 208 may include software and/or logic to provide functionality for transferring the earnest money deposit in a real estate transaction to an escrow account. Earnest money deposit represents a buyer's good faith to buy a property from a seller. The entity controlling the escrow server 101 may hold all the money and documents related to the real estate transaction until everything has been settled. Once all procedural formalities are completed, the money and documents are released from the escrow account to the seller and buyer, thus guaranteeing a secure transaction. In some implementations, the earnest payment engine 208 determines an amount of the earnest money based on a percentage of the purchase price of the property. For example, the amount of the earnest money may be in a range between 1% and 10% of the purchase price. In another example, the amount of the earnest money as a percentage of the purchase price may be stipulated by the real estate statutory and regulatory requirements for the geographical location.

In some implementations, the earnest payment engine 208 may be configured to implement one or more machine learning models 226 trained by the machine learning engine 204 to execute its functionality as described herein. For example, the earnest payment engine 208 may input real estate market data, real estate transaction price, the timeline of the real estate closing, buyer's mortgage preapproval, number of offers on the property, days on the market, etc. into a trained machine learning model 226 to determine a recommendation of an amount or value of earnest money deposit in a real estate transaction event. The earnest payment engine 208 sends instructions to the user interface engine 210 for displaying one or more user interfaces to facilitate the transfer of earnest money deposit into an escrow account.

As shown in the examples of FIGS. 3A-3I, the graphical representations illustrate one embodiment of a process for guiding a user through a process of electronically submitting earnest money deposit to an escrow account. In FIG. 3A, the graphical representation 300 includes an example user interface for initiating the transfer of the earnest money deposit. When the user selects the “Submit Earnest Money” button 303, the earnest payment engine 208 sends instructions to the user interface engine 210 to present a pop up window 305 in the user interface. The earnest payment engine 208 determines a current status of the real estate transaction event and whether the due date for the earnest money deposit indicates availability of a sufficient window of time for transferring payment through an automated clearing house (ACH) in a timely manner to meet the deadline of the due date. For example, a settlement of payment via ACH credit transactions takes a minimum of 24 hours to process. If the current status (e.g., active with contract, under contract, deal pending, etc.) of the real estate transaction event is indicative that the real estate transaction is in progress and/or the available window of time (e.g., 24 hours, 36 hours, etc.) is sufficient to meet the deadline of the due date for depositing the earnest money in time, the earnest payment engine 208 enables electronic funds transfer (e.g., digital deposit) as a mode for transferring the earnest money amount to the escrow account. In FIG. 3A, for example, the digital deposit option 307 is enabled for the user to select and proceed with making the payment for earnest money deposit. If the window of time is insufficient (e.g., less than 24 hours for same day ACH credit transaction) and/or the current status is indicative of a stalling in the real estate transaction, the earnest payment engine 208 disables electronic deposit. The user may choose to transfer the funds for earnest money via wire transfer or a personal check in such cases. In some implementations, the earnest payment engine 208 determines whether an amount of the earnest money is under or equivalent to a threshold amount set by a regulatory authority for electronic funds transfer (e.g., same day ACH transfers) and enables electronic funds transfer if the amount is under or equivalent to the threshold amount. Otherwise, the earnest payment engine 208 disables electronic funds transfer. For example, the earnest payment engine 208 determines whether the earnest money amount is under or equivalent to $25,000 (the ACH transaction limit set by Nacha). If the earnest money amount is under or equivalent to $25,000, the earnest payment engine 208 enables the electronic deposit option.

The earnest payment engine 208 invokes an API service of a trusted third-party system or framework, such as the digital banking integration system 130 in FIG. 1 to connect with one or more bank accounts of a user at a financial institution. In some implementations, the earnest payment engine 208 receives instructions from the digital banking integration system 130 for displaying one or more user interfaces to link a bank account of the user with the PSA application 103. In FIG. 3B, the graphical representation 320 includes a user interface shown to the user in response to the user selecting “Connect to your bank” button 309 in FIG. 3A. In FIG. 3B, the user may agree to begin linking with the bank account using the API service of the digital banking integration system 130 by selecting the agree button 321. In FIG. 3C, the graphical representation 330 includes a user interface with a pop up window 317 for the user to select a bank 319 from a list of banks supported by the digital banking integration system 130.

The digital banking integration system 130 enables integration with the online banking services of the banks. The digital banking integration system 130 constantly updates its list of supported banks. If the user were to select “Bank 1” 319 as the bank to link in FIG. 3C, the graphical representation 340 in FIG. 3D displays a user interface for logging into the online banking service of selected bank. In FIG. 3D, the user interface in the graphical representation 340 shows a pop up window 321 for the user to enter their username and password in association with the selected bank. When the user credentials are successfully authenticated with the selected bank using the username and password, the earnest payment engine 208 receives a public token from the API of the digital banking integration system 130 indicating that one or more bank accounts of the user in Bank 1 has now been linked to the PSA application 103. In FIG. 3E, the graphical representation 350 includes a user interface with a pop up window 325 displaying a notification that the bank account of the user has been successfully linked to the PSA application 103.

The earnest payment engine 208 uses the public token to query the digital banking integration system 130 and access bank account information of a successfully linked bank. In some implementations, the earnest payment engine 208 sends the public token to the digital banking integration system 130 to exchange for an access token. In response to exchange request, the digital banking integration system 130 verifies the public token and sends the access token to the earnest payment engine 208. For example, the access token may correspond to and uniquely identify the linked bank of a user. The earnest payment engine 208 stores the access token in the data storage 243. The earnest payment engine 208 uses the access token to retrieve information about a list of bank accounts of the user at the linked bank from the digital banking integration system 130. For example, the earnest payment engine 208 may retrieve information, such as account number, type of account, institution name, routing number, account holder name, recent transactions, and a balance for each bank account of the user at the linked bank. The earnest payment engine 208 determines an eligibility of the list of bank accounts. The earnest payment engine 208 filters the list of accounts to determine eligible accounts to fund the earnest money deposit. For example, an eligible account may be an account having a balance that is greater than the payment amount due for the earnest money deposit or sufficient to fund an electronic transfer of the earnest money deposit. The earnest payment engine 208 also identifies a type of the account to determine its eligibility to fund earnest money deposit transfer. In another example, an eligible account may be a checking account or a savings account. The earnest payment engine 208 sends instructions to the user interface engine 210 to display a user interface with the eligible accounts available for user selection. In FIG. 3F, the graphical representation 360 includes a user interface with a pop up window 365 displaying the eligible bank accounts available for the user selection. For example, the eligible bank accounts are checking account 361 and the savings account 363. In the graphical representation 360, the user interface disables accounts, such as the mortgage account, the student loan account, the 401k account, and money market account from user selection because they are ineligible to be used to fund the earnest money deposit. In some implementations, the earnest payment engine 208 sends instructions to the user interface engine 210 to display the user interface in FIG. 3F to include only one or more eligible bank accounts. Any ineligible bank account may simply not be shown.

The earnest payment engine 208 electronically transfers the earnest money deposit from a linked bank account of a user (e.g., buyer) to an escrow account. The earnest payment engine 208 automatically creates a customer account for a user (e.g., payment sender) on the digital payment server 120 when the user is identified as a party (e.g., buyer) in a real estate transaction. In some implementations, the earnest payment engine 208 automatically creates a customer account for the user when the transaction engine 202 creates a user profile 222 for the potential buyer. For example, the earnest payment engine 208 may use a first name, a last name, an email address, and Internet protocol (IP) address (optional) to create an initial unverified customer account for the buyer.

The earnest payment engine 208 sends one or more separate API calls hidden from the end user to seamlessly complete the electronic transfer of earnest money deposit. One example of optimizing the end-to-end PSA process with a simple and secure user experience by bundling user interactions involved in a real estate transaction event into a fewer number of steps is evident in the transfer of earnest money deposit. For example, the amount of earnest deposit to transfer and the target escrow account is automatically preset for the transfer without requiring any user intervention. The user merely provides a selection of a bank account (after securely authenticating with the online banking service of the bank) and personal information for payment verification. In FIG. 3F, for example, the earnest payment engine 208 receives a user selection of an eligible bank account to fund the earnest money deposit. The user selects checking account 361 as a funding source for earnest money deposit. In response to receiving the user selection of the eligible bank account, the earnest payment engine 208 sends instructions to the user interface engine 207 to display a user interface for obtaining personal information of the user (e.g., payment sender) for payment verification. In FIG. 3G, the graphical representation 370 shows a user interface with a pop up 371 prompting the user to provide personal information, such as name, phone, email, address, date of birth, last 4 digits of social security number, etc. In FIG. 3H, the graphical representation 380 shows a user interface with a pop up 381 for the user to review personal account and payment information before authorizing the submission of payment on the earnest money deposit by selecting the “Summit Earnest Money” button 383. In response to receiving the authorization to submit earnest money deposit, the earnest payment engine 208 passes the collected information including personal information, selected bank account, and payment details (e.g., earnest money amount, task, escrow target account, etc.) to the digital payment server 120 in one or more separate API calls.

The earnest payment engine 208 creates a verified customer account for the buyer on the digital payment server 120 using the complete personal information. The digital payment server 120 generates a unique customer uniform resource locator (URL) and sends it to the earnest payment engine 208. The earnest payment engine 208 stores the unique customer URL in the data storage 243.

The earnest payment engine 208 invokes an API service of the digital banking integration system 130 to generate a processor token for enabling the digital payment. The earnest payment engine 208 sends the access token and the identifier of the selected bank account to the digital banking integration system 130. The digital banking integration system 130 creates a processor token for the selected bank account and returns it to the earnest payment engine 208. The earnest payment engine 208 combines the processor token with the unique customer URL to set up a unique funding source URL that belongs to the payment sender at the digital payment server 120. The earnest payment engine 208 initiates the transfer with the set earnest money deposit amount and target escrow account using the unique funding source URL.

The digital payment server 120 processes the API calls to verify the user (e.g., payment sender), create a customer account for the user, add bank account as a funding source, and initiate the payment using the payment details. If one or more of the separate API calls fail to be processed, the digital payment server 120 intimates the earnest payment engine 208 about an error in processing the payment. The earnest payment engine 208 sends instructions to the user interface engine 207 for displaying a user interface notifying the user about an error in processing the payment. When the digital payment server 120 successfully processes the collected information in the API calls and initiates the payment transfer, the earnest payment engine 208 sends instructions to the user interface engine 207 for displaying a user interface informing the user about the earnest money deposit being transferred. In FIG. 3I, the graphical representation 390 shows an example user interface with a pop up window 397 for notifying the user with a congratulatory message indicating that the payment is being transferred to a target escrow account. The earnest payment engine 208 tracks the transfer of earnest money deposit from the user's bank account through ACH and generates notification receipts for the parties (e.g., buyer, seller, and agents) involved in the transaction.

The user interface engine 210 may include software and/or logic for providing user interfaces to a user. In some implementations, the user interface engine 210 receives instructions from the components 202, 204, 206, 208, and 210, generates a user interface according to the instructions, and transmits the user interface for display on the client device 115 as described above with reference to FIGS. 3A-3I. In some implementations, the user interface engine 210 sends graphical user interface data to an application (e.g., a browser) in the client device 115 via the communication unit 241 causing the application to display the data as a graphical user interface.

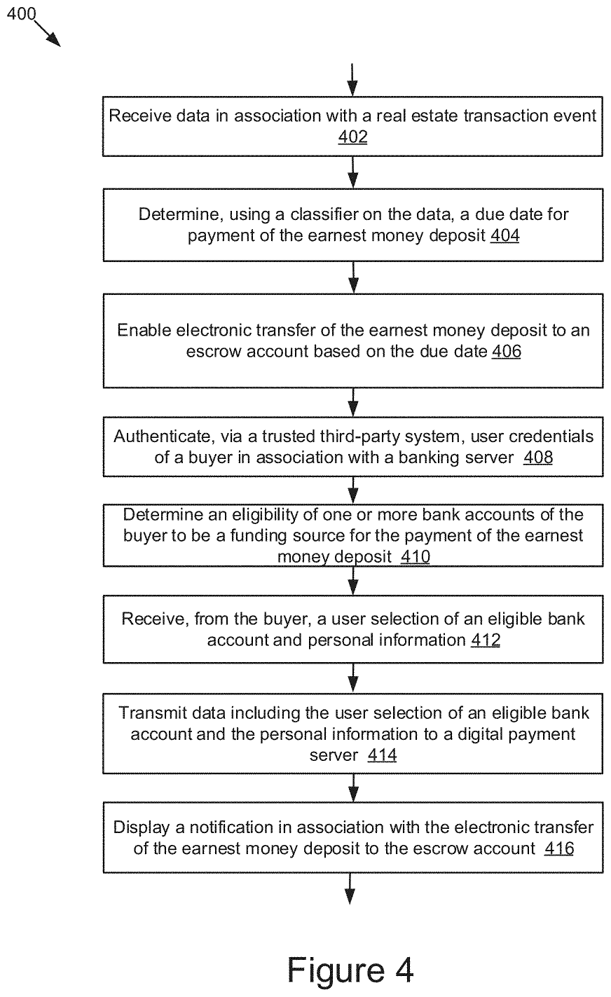

FIG. 4 is a flow diagram illustrating one embodiment of an example method 400 for facilitating an electronic transfer of digital earnest money deposit. At 402, the transaction engine 202 receives data in association with a real estate transaction event. For example, the transaction data may include, for example, the address of the real estate listing, the primary buyer, the primary seller, one or more real estate agents, mutual acceptance date of an offer, etc. At 404, the timeline engine 206 determines, using a classifier, a due date for payment of the earnest money deposit. The timeline engine 206 may also determine, using another classifier, a value of earnest money deposit for the real estate transaction. At 406, the earnest payment engine 208 enables electronic transfer of the earnest money deposit to an escrow account based on the due date. For example, the due date has to satisfy a threshold period of time (e.g., 24 hours) available for timely settlement of payment in order to enable the electronic transfer of the earnest money deposit. At 408, the earnest payment engine 208 authenticates, via a trusted third-party system, user credentials of a buyer in association with a banking server. At 410, the earnest payment engine 208 determines an eligibility of one or more bank accounts of the buyer to be a funding source for the payment of the earnest money deposit. For example, a checking account or a savings account may be determined eligible. In another example, the account balance in the bank account has to be sufficient to fund the payment of earnest money deposit in order to be determined eligible. At 412, the earnest payment engine 208 receives, from the buyer, a user selection of an eligible bank account and personal information. For example, the personal information includes a name, a phone number, an email address, the payment sender's address, date of birth, and a unique identifier (e.g., last 4 digits of social security number, driver license identification number, state identification card number, etc.). At 414, the earnest payment engine 208 transmits data including the user selection of an eligible bank account and the personal information to a digital payment server. At 416, the earnest payment engine 208 displays a notification in association with the electronic transfer of the earnest money deposit to the escrow account.

A system and method for providing a simple and secure user experience by bundling user interactions involved in a real estate transaction event into a fewer number of steps has been described. In the above description, for purposes of explanation, numerous specific details are set forth in order to provide a thorough understanding of the techniques introduced above. It will be apparent, however, to one skilled in the art that the techniques can be practiced without these specific details. In other instances, structures and devices are shown in block diagram form in order to avoid obscuring the description and for ease of understanding. For example, the techniques are described in one embodiment above primarily with reference to software and particular hardware. However, the present invention applies to any type of computing system that can receive data and commands, and present information as part of any peripheral devices providing services.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some portions of the detailed descriptions described above are presented in terms of algorithms and symbolic representations of operations on data bits within a computer memory. These algorithmic descriptions and representations are, in some circumstances, used by those skilled in the data processing arts to convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing”, “computing”, “calculating”, “determining”, “displaying”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The techniques also relate to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer readable storage medium, such as, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

Some embodiments can take the form of an entirely hardware embodiment, an entirely software embodiment or an embodiment containing both hardware and software elements. One embodiment is implemented in software, which includes but is not limited to firmware, resident software, microcode, etc.

Furthermore, some embodiments can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A data processing system suitable for storing and/or executing program code can include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description above. In addition, the techniques are not described with reference to any particular programming language. It will be appreciated that a variety of programming languages may be used to implement the teachings of the various embodiments as described herein.

The foregoing description of the embodiments has been presented for the purposes of illustration and description. It is not intended to be exhaustive or to limit the specification to the precise form disclosed. Many modifications and variations are possible in light of the above teaching. It is intended that the scope of the embodiments be limited not by this detailed description, but rather by the claims of this application. As will be understood by those familiar with the art, the examples may be embodied in other specific forms without departing from the spirit or essential characteristics thereof. Likewise, the particular naming and division of the modules, routines, features, attributes, methodologies and other aspects are not mandatory or significant, and the mechanisms that implement the description or its features may have different names, divisions and/or formats. Furthermore, as will be apparent to one of ordinary skill in the relevant art, the modules, routines, features, attributes, methodologies and other aspects of the specification can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, and/or in every and any other way known now or in the future to those of ordinary skill in the art of computer programming. Additionally, the specification is in no way limited to embodiment in any specific programming language, or for any specific operating system or environment. Accordingly, the disclosure is intended to be illustrative, but not limiting, of the scope of the specification, which is set forth in the following claims.

What is claimed is:

1. A computer-implemented method comprising:
receiving data in association with a real estate transaction event;
determining, using a first classifier on the data, a due date for payment of earnest money deposit to a target escrow account;
enabling electronic transfer of the earnest money deposit to the target escrow account based on the due date;
authenticating, via a trusted third-party system, user credentials of a buyer in association with a bank;
determining an eligibility of one or more bank accounts of the buyer to be a funding source for the payment of the earnest money deposit;
receiving, from the buyer, a user selection of an eligible bank account and personal information;
transmitting data including the user selection of an eligible bank account and personal information to a digital payment server; and
presenting a notification in association with the electronic transfer of the earnest money deposit to the target escrow account.

2. The computer-implemented method of claim 1, wherein enabling the electronic transfer of the earnest money deposit to the target escrow account based on the due date comprises:
determining whether the due date satisfies a threshold period of time available for timely settlement of payment; and
responsive to determining that the due date satisfies a threshold period of time available for timely settlement of payment, enabling the electronic transfer of the earnest money deposit to the target escrow account.

3. The computer-implemented method of claim 1, further comprising:
responsive to authenticating the user credentials of the buyer in association with the bank, receiving, from the trusted third-party system, a public token;
exchanging the public token with the trusted third-party system for an access token; and
retrieving the one or more bank accounts from the trusted third-party system using the access token.

4. The computer-implemented method of claim 1, wherein determining the eligibility of the one or more bank accounts of the buyer to be a funding source comprises:
determining whether an account type of the one or more bank accounts is one from a group of a checking account and a savings account; and
responsive to determining that the account type of the one or more bank accounts is one from a group of a checking account and a savings account, making the one or more bank accounts available for the user selection.

5. The computer-implemented method of claim 1, wherein determining the eligibility of the one or more bank accounts of the buyer to be a funding source comprises:
determining whether an account balance in the one or more bank accounts is sufficient to fund the payment of earnest money deposit; and
responsive to determining that the account balance in the one or more bank accounts is sufficient to fund the payment of earnest money deposit, making the one or more bank accounts available for the user selection.

6. The computer-implemented method of claim 5, further comprising responsive to determining that the account balance in the one or more bank accounts is insufficient to fund the payment of earnest money deposit, making the one or more bank accounts unavailable for the user selection.

7. The computer-implemented method of claim 1, further comprising determining, using a second classifier on the data, a value of the earnest money deposit.

8. The computer-implemented method of claim 1, wherein transmitting the data including the user selection of the eligible bank account and the personal information to the digital payment server comprises:
transmitting a first application programming interface (API) call to the digital payment server to create a customer account for the buyer using the personal information;
transmitting a second API call to the digital payment server to add the user selection of the eligible bank account as a funding source for the electronic transfer of the earnest money deposit to the target escrow account; and
transmitting a third API call to the digital payment server to initiate the electronic transfer of the earnest money deposit to the target escrow account.

9. The computer-implemented method of claim 1, wherein the personal information comprises one or more of a name, a phone number, an email address, a payment sender's address, date of birth, and a unique identifier.

10. The computer-implemented method of claim 1, wherein enabling electronic transfer of the earnest money deposit to the target escrow account is further based on one or more of a status of the real estate transaction event and an amount of the earnest money deposit.

11. A system comprising:
one or more processors; and
a memory, the memory storing instructions, which when executed cause the one or more processors to:
receive data in association with a real estate transaction event;
determine, using a first classifier on the data, a due date for payment of earnest money deposit to a target escrow account;
enable electronic transfer of the earnest money deposit to the target escrow account based on the due date;
authenticate, via a trusted third-party system, user credentials of a buyer in association with a bank;
determine an eligibility of one or more bank accounts of the buyer to be a funding source for the payment of the earnest money deposit;
receive, from the buyer, a user selection of an eligible bank account and personal information;
transmit data including the user selection of an eligible bank account and personal information to a digital payment server; and
present a notification in association with the electronic transfer of the earnest money deposit to the target escrow account.

12. The system of claim 11, wherein to enable the electronic transfer of the earnest money deposit to the target escrow account based on the due date, the instructions further cause the one or more processors to:
determine whether the due date satisfies a threshold period of time available for timely settlement of payment; and
responsive to determining that the due date satisfies a threshold period of time available for timely settlement of payment, enable the electronic transfer of the earnest money deposit to the target escrow account.

13. The system of claim 11, wherein the instructions further cause the one or more processors to:
responsive to authenticating the user credentials of the buyer in association with the bank, receive, from the trusted third-party system, a public token;
exchange the public token with the trusted third-party system for an access token; and
retrieve the one or more bank accounts from the trusted third-party system using the access token.

14. The system of claim 11, wherein to determine the eligibility of the one or more bank accounts of the buyer to be a funding source, the instructions further cause the one or more processors to:
determine whether an account type of the one or more bank accounts is one from a group of a checking account and a savings account; and
responsive to determining that the account type of the one or more bank accounts is one from a group of a checking account and a savings account, make the one or more bank accounts available for the user selection.

15. The system of claim 11, wherein to determine the eligibility of the one or more bank accounts of the buyer to be a funding source, the instructions further cause the one or more processors to:
determine whether an account balance in the one or more bank accounts is sufficient to fund the payment of earnest money deposit; and
responsive to determining that the account balance in the one or more bank accounts is sufficient to fund the payment of earnest money deposit, make the one or more bank accounts available for the user selection.

16. The system of claim 15, wherein the instructions further cause the one or more processors to make the one or more bank accounts unavailable for the user selection responsive to determining that the account balance in the one or more bank accounts is insufficient to fund the payment of earnest money deposit.

17. The system of claim 11, wherein the instructions further cause the one or more processors to determine, using a second classifier on the data, a value of the earnest money deposit.

18. The system of claim 11, wherein to transmit the data including the user selection of the eligible bank account and the personal information to the digital payment server, the instructions further cause the one or more processors to:
transmit a first application programming interface (API) call to the digital payment server to create a customer account for the buyer using the personal information;
transmit a second API call to the digital payment server to add the user selection of the eligible bank account as a funding source for the electronic transfer of the earnest money deposit to the target escrow account; and
transmit a third API call to the digital payment server to initiate the electronic transfer of the earnest money deposit to the target escrow account.

19. The system of claim 11, wherein the personal information comprises one or more of a name, a phone number, an email address, a payment sender's address, date of birth, and a unique identifier.

20. The system of claim 11, wherein the electronic transfer of the earnest money deposit to the target escrow account is further enabled based on one or more of a status of the real estate transaction event and an amount of the earnest money deposit.
